(19) United States
(12) Patent Application Publication
(10) Pub. No.: US 2014/0157161 A1
(43) Pub. Date: Jun. 5, 2014

(54) VARIABLE OPACITY ON-SCREEN KEYBOARD

(71) Applicant: LENOVO (SINGAPORE) PTE. LTD., Singapore (SG)

(72) Inventors: John Miles Hunt, Raleigh, NC (US); Howard Locker, Cary, NC (US); John Weldon Nicholson, Cary, NC (US); Scott Edwards Kelso, Cary, NC (US); Steven Richard Perrin, Raleigh, NC (US)

(73) Assignee: Lenovo (Singapore) Pte. Ltd., Singapore (SG)

(21) Appl. No.: 13/690,390

(22) Filed: Nov. 30, 2012

(51) Int. Cl. G06F 3/0484

(52) U.S. Cl. CPC G06F 3/04847
USPC 715/768

(57) ABSTRACT

An aspect provides a method, including: determining, at an information handling device, user input triggering display of an on-screen keyboard; and displaying the on-screen keyboard on a touch screen display of the information handling device according to a variable opacity setting; wherein the variable opacity setting establishes at least an initial opacity of the on-screen keyboard, and further wherein at least one sub-portion of the on-screen keyboard is semi-transparent. Other aspects are described and claimed.

### BACKGROUND

Information handling devices (“devices”), for example mobile devices such as tablet computing devices, smart phones, e-readers, etc., provide for user input entry via an on-screen keyboard. The on-screen keyboard (sometimes referred to as a “virtual” keyboard) is conventionally displayed as an overlay display (e.g., overlaying an underlying document display, such as a web page) or as a dedicated area of the screen, with the remainder of the display resized. In any event, conventional on-screen keyboards obscure at least a portion of the main display, i.e., that containing the underlying or main content, e.g., a web page, or by occupying a portion of the display screen that would normally contain the main content.

The user is able to enter text, numbers, symbols, etc., via touching the soft keys or employing a swiping motion to provide serial key entries, or some like entry input. The user completes the input and the on-screen keyboard is removed, with the main display content being re-displayed (e.g., uncovered or resized), updated accordingly.

### BRIEF SUMMARY

In summary, one aspect provides a method, comprising: determining, at an information handling device, user input triggering display of an on-screen keyboard; and displaying the on-screen keyboard on a touch screen display of the information handling device according to a variable opacity setting; wherein the variable opacity setting establishes at least an initial opacity of the on-screen keyboard, and further wherein at least one sub-portion of the on-screen keyboard is semi-transparent.

Another aspect provides an information handling device, comprising: a touch screen display; one or more processors; and a memory operatively coupled to the one or more processors that stores instructions executable by the one or more processors to perform acts comprising: determining, at the information handling device, user input triggering display of an on-screen keyboard; and displaying the on-screen keyboard on the touch screen display of the information handling device according to a variable opacity setting; wherein the variable opacity setting establishes at least an initial opacity of the on-screen keyboard, and further wherein at least one sub-portion of the on-screen keyboard is semi-transparent.

A further aspect provides a program product, comprising: a storage medium having computer program code embodied therewith, the computer program code comprising: computer program code configured to determine, at an information handling device, user input triggering display of an on-screen keyboard; and computer program code configured to display the on-screen keyboard on a touch screen display of the information handling device according to a variable opacity setting; wherein the variable opacity setting establishes at least an initial opacity of the on-screen keyboard, and further wherein at least one sub-portion of the on-screen keyboard is semi-transparent.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example information handling device and components thereof.

FIG. 2 illustrates an example of opacity for an on-screen keyboard and components thereof.

FIG. 3 illustrates an example method of displaying an on-screen keyboard according to an initial opacity setting.

FIG. 4 illustrates an example method of adjusting the initial opacity setting of an on-screen keyboard.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

On-screen keyboards, e.g., as displayed on touch screen devices, conventionally activate when the user requires text input and occupy a significant portion of the screen. Mobile operating systems either slide the content being viewed up, or allow the keyboard to slide over it. Either way, the user's ability to view the main content (e.g., a web page) is severely restricted while the keyboard is activated, as on-screen keyboards are opaque (e.g., have a black background obscuring the underlying content). To date, all touch devices accept occlusion of content when the on-screen keyboard is active. This causes problems with user confusion and loss of focus on the main content.

Accordingly, an embodiment eschews moving the content at all and instead renders the keyboard with variable opacity. There are many opacity schemes that may be used. A simple example is an on-screen keyboard at a fixed (but configurable opacity), for example providing a semi-transparent on-screen keyboard display that only partially obscures the underlying content.

Another embodiment varies the opacity in real-time, for example responsive to user inputs such as user typing actions. For example, upon activating the on-screen keyboard, an embodiment displays it initially at a set maximum opacity (that may be configurable by the user). Each successful keystroke then reduces the on-screen keyboard's opacity by a certain amount, such that, as the user types more quickly, the on-screen keyboard's opacity approaches a minimum value. The reverse of this reduction may be implemented, e.g., increasing the opacity with successful keystrokes.

In the absence of keystrokes, the on-screen keyboard's opacity may begin to increase to its previous maximum, or conversely, decrease to a minimum opacity. This provides for visual assistance with mistakes and slowdowns, and may be augmented by display of additional help information (e.g., a help window). The user will reach opacity equilibrium when typing and will consequently enjoy a clearer view of the displayed content underlying a semi-transparent/reduced opacity on-screen keyboard.

The illustrated example embodiments will be best understood by reference to the figures. The following description is intended only by way of example, and simply illustrates certain example embodiments.

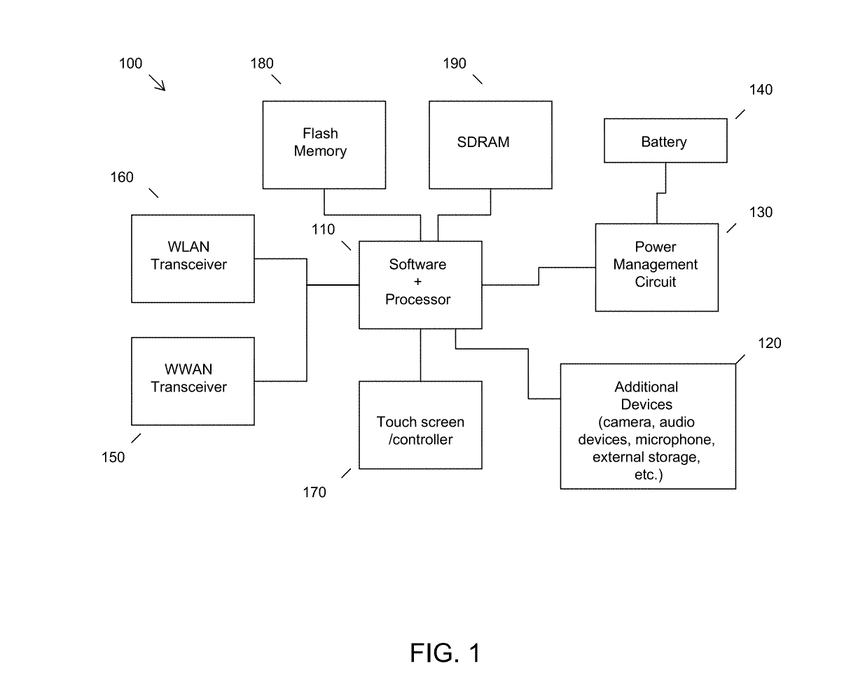

Referring to FIG. 1, while various other circuits, circuitry or components may be utilized, with regard to smart phone and/or tablet circuitry 100, an example illustrated in FIG. 1 includes an ARM based system (system on a chip) design, with software and processor(s) combined in a single chip 110. Internal busses and the like depend on different vendors, but essentially all the peripheral devices (120) may attach to a single chip 110. The tablet circuitry 100 combines the processor, memory control, and I/O controller hub all into a single chip 110. Also, ARM based systems 100 do not typically use SATA or PCI or LPC. Common interfaces for example include SDIO and I2C. There are power management chip(s) 130, which manage power as supplied for example via a rechargeable battery 140, which may be recharged by a connection to a power source (not shown), and in at least one design, a single chip, such as 110, is used to supply BIOS like functionality and DRAM memory.

ARM based systems 100 typically include one or more of a WWAN transceiver 150 and a WLAN transceiver 160 for connecting to various networks, such as telecommunications networks and wireless base stations. Commonly, an ARM based system 100 will include a touch screen 170 for data input and display. ARM based systems 100 also typically include various memory devices, for example flash memory 180 and SDRAM 190.

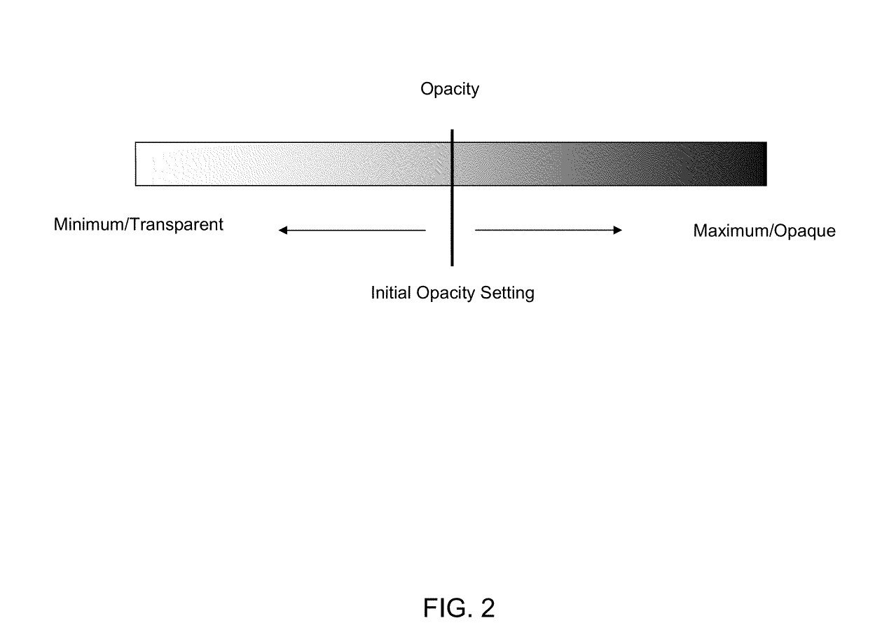

Devices such as outlined in FIG. 1 may be utilized to provide on-screen keyboards for user input, for example via touch screen 170. On the touch screen 170, an opacity of the on-screen keyboard display (or sub-portion thereof) may be varied in opacity, as illustrated in FIG. 2. Thus, an initial opacity setting may be chosen, for example as illustrated in FIG. 2 where the initial opacity setting is semi-transparent. This initial opacity setting may be applied to the entire on-screen keyboard or a sub-portion thereof, for example applied to display areas surrounding keys (e.g., background of the on-screen keyboard display), a sub-set of keys, a preview bar or bubble, or the like.

The initial opacity setting may be user configurable or adjustable. For example, a user may be provided with a visual interface, such as illustrated in the example of FIG. 2, which provides the user with a slider bar that adjusts the initial opacity between a minimum and a maximum. More refined interfaces may be utilized, such as providing a similar slider bar interface as illustrated in FIG. 2 for each user adjustable sub-portion of the on-screen keyboard. Therefore, an embodiment allows a user to adjust the opacity metric to be initially applied. Similarly, as further described herein, in an embodiment that varies the initial opacity setting, e.g., in response to user input, may be adjusted by the user. Thus, a user may for example adjust the rate of opacity change, bound the minimum and maximum change for the initial opacity setting, and the like.

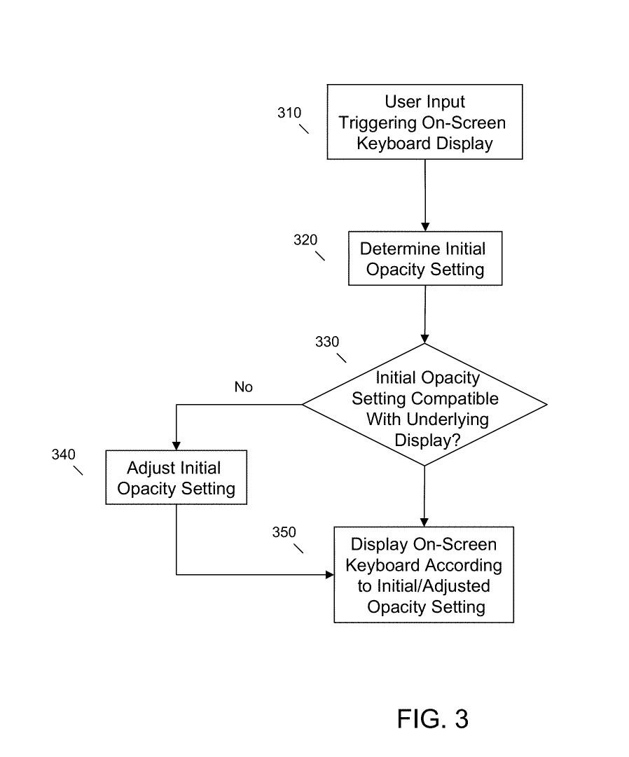

In FIG. 3 an example method of setting an on-screen keyboard to an initial opacity setting is illustrated. At 310 a user input triggers display of an on-screen keyboard, for example a user touching a text entry box on a web page displayed on a touch screen display. An embodiment ascertains an initial opacity setting at 320, such as a setting entered by a user via an interface such as illustrated in FIG. 2 (or a provided default) saved into a memory of the information handling device. The initial opacity setting informs an embodiment of what the user (or default) initial opacity setting is, e.g., semi-transparent opacity applied to an entire on-screen keyboard).

At 330 an embodiment may take into account what is being displayed in the main/underlying display. This optional step may be appropriate in certain circumstances, such as for example when the on-screen keyboard font color (e.g., yellow), for example as selected by the user, is incompatible with the underlying display (e.g., a largely white web page). Thus, the initial opacity setting of semi-transparent (in this example), may be unsuitable for use with the other settings of the on-screen keyboard when considered in combination with the underlying content. Thus, an embodiment may determine at 330 there is incompatibility and automatically adjust the initial opacity setting at 340. This may be as simple as increasing the initial opacity setting, decreasing the initial opacity setting, or prompting the user to make a selection, e.g., switching font color, initial opacity setting or the like.

If there is compatibility between the initial opacity setting and the underlying content, or if this step is omitted (e.g., because a neutral/safe color such as gray or black is chosen for on-screen font color), an embodiment may display the on-screen keyboard according to the initial opacity setting (e.g., semi-transparent) without first adjusting the initial opacity setting. Thus, the user is provided with an on-screen keyboard that does not unduly obscure the underlying content.

An embodiment may vary the initial opacity setting responsive to several ascertained parameters, including but not limited to change in underlying display (e.g., change in web page color, intensity) and/or user inputs. For example, a user may manually adjust the initial opacity setting after seeing the result of the on-screen display, for example using an interface such as illustrated in FIG. 2.

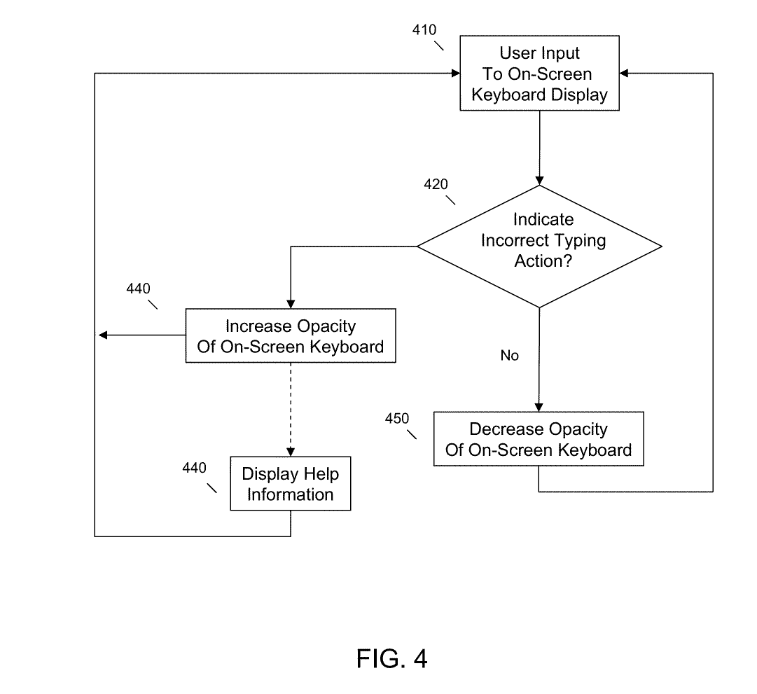

Moreover, an embodiment may dynamically adjust the initial opacity setting, e.g., in real time in response to user inputs. In a non-limiting example, referring to FIG. 4, a user may provide input to an on-screen keyboard at 410. At 420, an embodiment may monitor the user input according to a variety of techniques to determine if the input is indicative of incorrect input, e.g., incorrect typing actions (such as misspellings, repeated backspace or delete key operations, selection of word correction(s) from a preview bar or bubble, etc.). This permits an embodiment to estimate the degree of difficulty the user is experiencing in providing input (e.g., typing input) and adjust the opacity of the on-screen keyboard accordingly.

Thus, responsive to a determination that the input indicates incorrect typing action at 420, an embodiment may increase the opacity of the on-screen keyboard at 430, affording a clearer view of the on-screen keyboard to assist the user in providing input thereto. Optionally, help information may be displayed, for example at 440 following repeated input indicative of incorrect typing actions even after increasing the opacity of the on-screen keyboard.

If the user is not providing input indicative of incorrect typing actions at 420, i.e., the user is providing input indicative of successful input, such as increased typing speed, low rate of mistakes, few corrections, and the like, an embodiment may decrease the opacity of the on-screen keyboard at 450. Thus, with successful use of the initially semi-transparent/opaque on-screen keyboard, a user may be presented with a successively less opaque/more transparent on-screen keyboard display at 450. This may be implemented by decreasing the initial opacity setting, e.g., as set via an interface such as illustrated in FIG. 2.

It should be noted that some users may prefer that the opacity of the on-screen keyboard increase while typing even if no incorrect typing actions are detected at 420. This would correspond to a user preferring to focus on typing while the typing action continues. Accordingly, an embodiment may essentially reverse the method illustrated in FIG. 4 for a successful user, i.e., increasing the opacity in response to successful typing actions at 450. Such an embodiment may then decrease the opacity following the typing actions, or during a lull in typing input, or the like.

As described herein, one or more sub-portions of the on-screen keyboard may have their opacity adjusted, and these adjustments may be variable in nature. For example, a background of the on-screen keyboard may quickly become transparent (at a first rate), while the keys themselves may reduce opacity at a slower, second rate. Moreover, the variability in opacity may be applied globally to the entire on-screen keyboard.

Thus, an embodiment provides a variable opacity on-screen keyboard to facilitate a more user-friendly visual experience when operating a touch screen display. The various embodiments have been described using specific examples (e.g., of particular documents, devices, device characteristics and the like) and these specific examples may be easily extended to other, like use contexts.

It will also be understood that the various embodiments may be implemented in one or more information handling devices configured appropriately to execute program instructions consistent with the functionality of the embodiments as described herein. In this regard, FIG. 1 illustrates a non-limiting example of such a device 200 and components thereof.

As will be appreciated by one skilled in the art, various aspects may be embodied as a system, method or computer program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

Any combination of one or more non-signal device readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider) or through a hard wire connection, such as over a USB connection.

Aspects are described herein with reference to the figures, which illustrate example methods, devices and program products according to various example embodiments. It will be understood that the actions and functionality illustrated may be implemented at least in part by program instructions. These program instructions may be provided to a processor of a general purpose information handling device, a special purpose information handling device, or other programmable data processing device or information handling device to produce a machine, such that the instructions, which execute via a processor of the device implement the functions/acts specified.

The program instructions may also be stored in a device/computer readable medium that can direct a device to function in a particular manner, such that the instructions stored in the device readable medium produce an article of manufacture including instructions which implement the function/act specified.

The program instructions may also be loaded onto a device to cause a series of operational steps to be performed on the device to produce a device implemented process such that the instructions which execute on the device provide processes for implementing the functions/acts specified.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
determining, at an information handling device, user input triggering display of an on-screen keyboard; and
displaying the on-screen keyboard on a touch screen display of the information handling device according to a variable opacity setting;
wherein the variable opacity setting establishes at least an initial opacity of the on-screen keyboard, and further wherein at least one sub-portion of the on-screen keyboard is semi-transparent.

2. The method of claim 1, wherein the initial opacity of the entire on-screen keyboard is semi-transparent.

3. The method of claim 1, wherein the initial opacity of the on-screen keyboard is user adjustable.

4. The method of claim 1, wherein the variable opacity setting further determines variation of the opacity of the on-screen keyboard according to one or more user inputs.

5. The method of claim 4, further comprising, responsive to user input indicative of correct typing action, reducing the opacity of the on-screen keyboard.

6. The method of claim 4, further comprising, responsive to user input indicative of incorrect typing action, increasing the opacity of the on-screen keyboard.

7. The method of claim 4, further comprising, responsive to user input indicative of correct typing action, increasing the opacity of the on-screen keyboard.

8. The method of claim 4, further comprising, responsive to user input indicative of incorrect typing action, displaying help information.

9. The method of claim 1, further comprising, for at least one sub-portion of the on-screen keyboard, determining an underlying display characteristic.

10. The method of claim 9, further comprising, for at least one sub-portion of the on-screen keyboard, adjusting the initial opacity setting of the on-screen keyboard according to a determined underlying display characteristic.

11. An information handling device, comprising:
a touch screen display;
one or more processors; and
a memory operatively coupled to the one or more processors that stores instructions executable by the one or more processors to perform acts comprising:
determining, at the information handling device, user input triggering display of an on-screen keyboard; and
displaying the on-screen keyboard on the touch screen display of the information handling device according to a variable opacity setting;
wherein the variable opacity setting establishes at least an initial opacity of the on-screen keyboard, and further wherein at least one sub-portion of the on-screen keyboard is semi-transparent.

12. The information handling device of claim 11, wherein the initial opacity of the entire on-screen keyboard is semi-transparent.

13. The information handling device of claim 11, wherein the initial opacity of the on-screen keyboard is user adjustable.

14. The information handling device of claim 11, wherein the variable opacity setting further determines variation of the opacity of the on-screen keyboard according to one or more user inputs.

15. The information handling device of claim 14, wherein the acts further comprise, responsive to user input indicative of correct typing action, reducing the opacity of the on-screen keyboard.

16. The information handling device of claim 14, wherein the acts further comprise, responsive to user input indicative of incorrect typing action, increasing the opacity of the on-screen keyboard.

17. The information handling device of claim 14, wherein the acts further comprise, responsive to user input indicative of correct typing action, increasing the opacity of the on-screen keyboard.

18. The information handling device of claim 14, wherein the acts further comprise, responsive to user input indicative of incorrect typing action, displaying help information.

19. The information handling device of claim 11, wherein the acts further comprise:
for at least one sub-portion of the on-screen keyboard, determining an underlying display characteristic; and
for at least one sub-portion of the on-screen keyboard, adjusting the initial opacity setting of the on-screen keyboard according to a determined underlying display characteristic.

20. A program product, comprising:
a storage medium having computer program code embodied therewith, the computer program code comprising:
computer program code configured to determine, at an information handling device, user input triggering display of an on-screen keyboard; and
computer program code configured to display the on-screen keyboard on a touch screen display of the information handling device according to a variable opacity setting;
wherein the variable opacity setting establishes at least an initial opacity of the on-screen keyboard, and further wherein at least one sub-portion of the on-screen keyboard is semi-transparent.
